(19) United States
(12) Patent Application Publication
(10) Pub. No.: US 2026/0279666 A1
(43) Pub. Date: Sep. 17, 2026

(54) MULTILAYER CERAMIC CAPACITOR

(71) Applicant: Murata Manufacturing Co., Ltd., Nagaokakyo-shi (JP)

(72) Inventor: Ryuya KOBAYASHI, Nagaokakyo-shi (JP)

(21) Appl. No.: 19/669,263

(22) Filed: May 6, 2026

Related U.S. Application Data
(63) Continuation of application No. PCT/JP2025/019923, filed on Jun. 2, 2025.

(30) Foreign Application Priority Data
Aug. 1, 2024 (JP) 2024-125656

(51) Int. Cl. H01G 4/008; H01G 4/12; H01G 4/232; H01G 4/248; H01G 4/30

(52) U.S. Cl. CPC H01G 4/008; H01G 4/1227; H01G 4/1236; H01G 4/2325; H01G 4/248; H01G 4/30

(57) ABSTRACT

In a multilayer ceramic capacitor, a dimension of a multilayer body in a width direction is greater than a dimension of the multilayer body in a length direction. Inner electrodes are provided as inner electrode groups each including a group of the inner electrodes, continuously adjacent to each other in a lamination direction, exposed at the same end surface, and the inner electrode groups each include an inner-side inner electrode that is the inner electrode closest to a central portion of the multilayer body in the lamination direction and the inner-side inner electrode that is the inner electrode closest to the surface of the multilayer body. The inner-side inner electrode of the inner electrode group of the inner electrode groups that is closest to the surface of the multilayer body includes an inner bent portion projecting toward the central portion of the multilayer body in the lamination direction.

### CROSS REFERENCE TO RELATED APPLICATIONS

This application claims the benefit of priority to Japanese Patent Application No. 2024-125656 filed on Aug. 1, 2024 and is a Continuation Application of PCT Application No. PCT/JP2025/019923 filed on Jun. 2, 2025. The entire contents of each application are hereby incorporated herein by reference.

### BACKGROUND OF THE INVENTION

### 1. Field of the Invention

The present invention relates to multilayer ceramic capacitors.

### 2. Description of the Related Art

Conventionally, there is a multilayer ceramic capacitor that includes a multilayer body in which a plurality of dielectric layers and a plurality of inner electrodes are alternately laminated together and outer electrodes provided on both end surfaces of the multilayer body. In recent years, a multilayer ceramic capacitor with excellent high-frequency characteristics has been developed (for example, Japanese Unexamined Patent Application Publication No. 2012-9817).

The multilayer ceramic capacitor in Japanese Unexamined Patent Application Publication No. 2012-9817 includes an inner electrode group including inner electrodes adjacent to each other in the lamination direction. As a result, a high Q value can be obtained in a high-frequency range. In a high-frequency circuit including a multilayer ceramic capacitor with a high Q value, energy loss in the high-frequency circuit is suppressed. In addition, in a multilayer ceramic capacitor in which the dimension in the width direction is greater than the dimension in the length direction, since the distance between the outer electrodes can be shorter and the dimension of the outer electrode in the width direction can be greater than the distance and the dimension of a standard multilayer ceramic capacitor, the ESL can be reduced.

### SUMMARY OF THE INVENTION

However, in the multilayer ceramic capacitor disclosed in Japanese Unexamined Patent Application Publication No. 2012-9817, the adhesion between the inner electrodes and the dielectric layers cannot be easily ensured around the inner electrode group. Accordingly, inner structural defects starting from a portion between the inner electrode and the dielectric layer, such as cracks or interlayer peeling, may occur. In particular, in a multilayer ceramic capacitor in which the dimension in the width direction is greater than the dimension in the length direction, the area of the gap portion from the end portion of the first inner electrode close to the second end surface in the length direction to the second end surface and the area of the gap portion from the end portion of the second inner electrode close to the first end surface in the length direction to the first end surface tend to be greater, and accordingly, inner structural defects starting from a portion between the inner electrode and the dielectric layer may easily occur.

Example embodiments of the present invention provide multilayer ceramic capacitors that each reduce or prevent energy loss in a high-frequency range and reduce or prevent inner structural defects while achieving ESL reduction effects.

According to an example embodiment of the present invention, a multilayer ceramic capacitor includes a multilayer body including an inner layer portion including a plurality of dielectric layers and a plurality of inner electrodes that are alternately laminated together, the multilayer body including a pair of main surfaces that face away from each other in a lamination direction, a pair of side surfaces that face away from each other in a width direction orthogonal to the lamination direction, and a pair of end surfaces that face away from each other in a length direction orthogonal to the lamination direction and the width direction; and outer electrodes, located on the end surfaces, that are connected to the inner electrodes, in which a dimension of the multilayer body in the width direction is greater than a dimension of the multilayer body in the length direction, the plurality of inner electrodes are provided as a plurality of inner electrode groups each including a group of the plurality of inner electrodes, continuously adjacent to each other in the lamination direction, that are exposed at one of the end surfaces, the inner electrode groups each include an inner-side inner electrode that is one of the inner electrodes of each of the inner electrode groups that is closest to a central portion of the multilayer body in the lamination direction, and an outer-side inner electrode that is one of the inner electrodes of each of the inner electrode groups that is closest to a surface of the multilayer body, and the inner-side inner electrode of the inner electrode group of the plurality of inner electrode groups that is closest to the surface of the multilayer body includes an inner bent portion projecting toward the central portion of the multilayer body in the lamination direction.

According to example embodiments of the present invention, it is possible to provide multilayer ceramic capacitors that each reduce or prevent energy loss in a high-frequency range and reduce or prevent inner structural defects while achieving ESL reduction effects.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor according to an example embodiment of the present invention.

FIG. 2 is a cross-sectional view taken along line II-II in FIG. 1.

FIG. 3 is a cross-sectional view taken along line III-III in FIG. 1.

FIG. 4 is an enlarged view of portion IV in FIG. 2.

### DETAILED DESCRIPTION OF THE EXAMPLE EMBODIMENTS

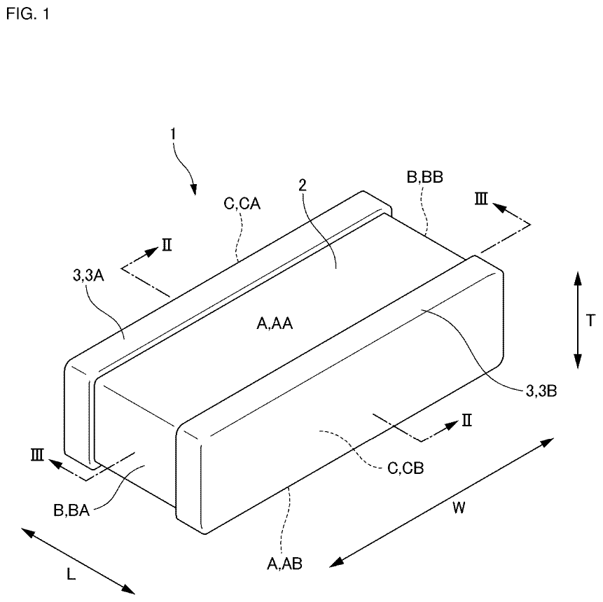

Multilayer ceramic capacitors according to example embodiments of the present invention will be described below with reference to FIGS. 1 to 4.

As illustrated in FIG. 1, a multilayer ceramic capacitor 1 according to an example embodiment of the present invention is a multilayer ceramic capacitor with a so-called two-terminal structure. The multilayer ceramic capacitor 1 includes a multilayer body 2 and a pair of outer electrodes 3. The multilayer body 2 has a substantially rectangular parallelepiped shape and has six outer surfaces. The multilayer body 2 includes an inner layer portion 11 in which dielectric layers 14 and the inner electrodes 15 are laminated together.

In this specification, the direction in which the dielectric layers 14 and the inner electrodes 15 are laminated together in the multilayer ceramic capacitor 1 is referred to as a lamination direction T. One of the directions that are orthogonal to the lamination direction T is referred to as a length direction L. The direction that is orthogonal to both the length direction L and the lamination direction T is referred to as a width direction W.

Of the six outer surfaces of the multilayer body 2, a pair of outer surfaces that are provided on both sides in the lamination direction T is referred to as a first main surface AA and a second main surface AB, a pair of outer surfaces, extending in the lamination direction T, that are provided on both sides in the width direction W is referred to as a first side surface BA and a second side surface BB, and a pair of outer surfaces, extending in the lamination direction T, that are provided on both sides in the length direction L is referred to as a first end surface CA and a second end surface CB.

The first main surface AA and the second main surface AB may be collectively referred to as main surfaces A. The first side surface BA and the second side surface BB may be collectively referred to as side surfaces B. The first end surface CA and the second end surface CB may be collectively referred to as end surfaces C.

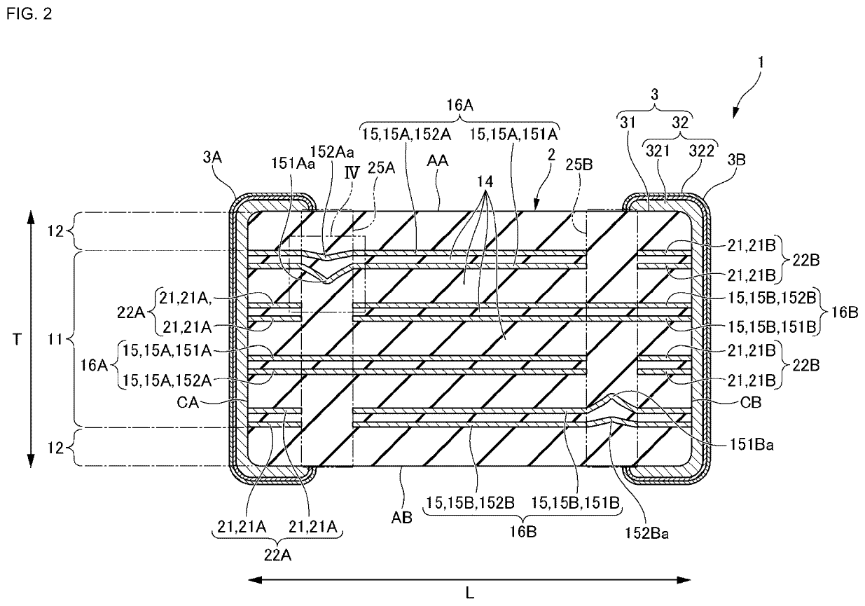

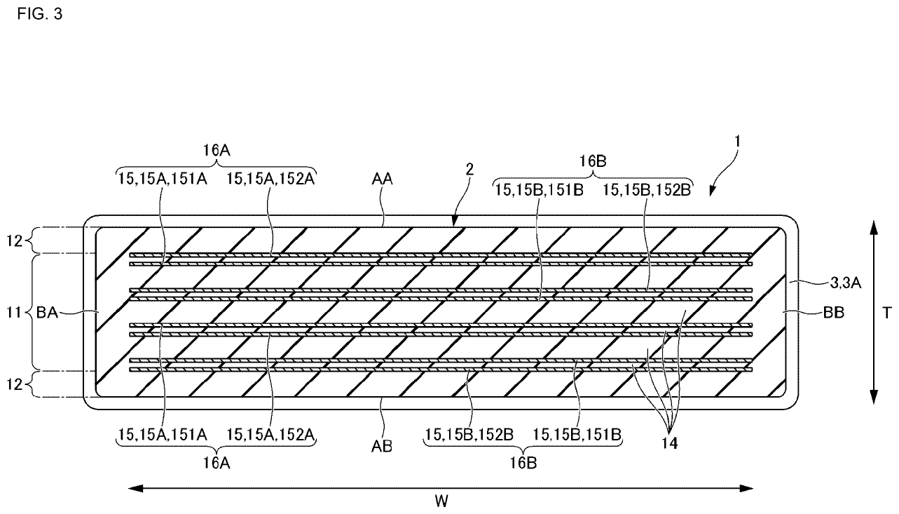

The cross-section parallel to the lamination direction T and the length direction L is referred to as an LT cross-section. The cross-section in FIG. 2 is an LT cross-section that passes through the central portion of the multilayer ceramic capacitor 1 in the width direction W. The cross-section parallel to the lamination direction T and the width direction W is referred to as a WT cross-section. The cross-section in FIG. 3 is a WT cross-section that passes through the central portion of the multilayer ceramic capacitor 1 in the length direction L.

The multilayer body 2 includes the inner layer portion 11 and a pair of outer layer portions 12 located on both sides of the inner layer portion 11 in the lamination direction T. A portion of the multilayer body 2 in which three outer surfaces intersect each other is referred to as a corner portion. A portion of the multilayer body 2 in which two outer surfaces intersect each other is referred to as a ridge portion. The corner portions and the ridge portions of the multilayer body 2 are preferably rounded.

The dimension of the multilayer body 2 in the width direction W is greater than the dimension of the multilayer body 2 in the length direction L. The dimension of the multilayer body 2 in the length direction L is, for example, about 0.2 mm or greater and about 0.6 mm or smaller. The dimension of the multilayer body 2 in the width direction W is, for example, about 0.4 mm or greater and about 1.0 mm or smaller. The dimension of the multilayer body 2 in the lamination direction T is, for example, about 0.1 mm or greater and about 0.9 mm or smaller. The outer dimensions of the multilayer ceramic capacitor 1 can be measured by using a micrometer.

As illustrated in FIGS. 2 and 3, the inner layer portion 11 includes the plurality of dielectric layers 14 and the plurality of inner electrodes 15. The dielectric layers 14 and the inner electrodes 15 are alternately laminated together.

The dielectric layer 14 is includes, as a main component, a ceramic material that includes at least one of Ca, Sr, Zr, and Ti.

For example, the dielectric layer 14 includes, as a main component, a ceramic material with a perovskite structure represented by the general formula ABO3 including Ca and Zr. The dielectric layer 14 has a composition represented by, for example, (Ca_{1-x-y}, Srₓ, Ba_{y})m(Zr_{1-z-α}, Ti_{z}, Hf_{α})O₃ where x is about 0 or greater and about 1 or smaller, y is about 0 or greater and about 0.4 or smaller, and m is about 1.0 or greater and about 1.1 or smaller, z is about 0 or greater and about 0.2 or smaller, and x is about 0 or greater and about 0.3 or smaller. The material of the dielectric layer 14 is, for example, CaZrO3 (calcium zirconate). The main component of the ceramic material that constitute the dielectric layer 14 may include all of Ca, Zr, and Ti. For example, the material of the dielectric layer 14 may be Ca (Zr_{0.9}Ti_{0.1})O3, which is a substance obtained by replacing a portion of ZrO3 or Zr in CaZrO3 with Ti.

In addition, the material of the dielectric layer 14 is not limited to the material that includes, as a main component, a ceramic material with a perovskite structure represented by the general formula ABO3 including Ca and Zr. The material of the dielectric layer 14 may be, for example, TiO2 (titanium oxide).

Preferably, the dielectric layer 14 includes TiO2 or has a composition represented by (Ca_{1-x-y}, Srₓ, Ba_{y})m(Zr_{1-z-α}, Ti_{z}, Hf_{α})O₃ where x is about 0 or greater and about 1 or smaller, y is about 0 or greater and about 0.4 or smaller, m is about 1.0 or greater and about 1.1 or smaller, z is about 0 or greater and about 0.2 or smaller, and a is about 0 or greater and about 0.3 or smaller.

Additives are added to the ceramic material that constitutes the dielectric layer 14 depending on the purpose. Such additives include, for example, Mn, Mg, Dy, Cr, oxides of rare earth elements such as V, Sm, Eu, Gd, Tb, Ho, Er, Tm, Yb, and Y, oxides of Co, Ni, Li, B, Na, K, and Si, or glass.

The thickness (that is, the dimension in the lamination direction T) of the dielectric layer 14 can be observed by measuring the distance between two adjacent first inner electrodes 15A or the distance between two adjacent second inner electrodes 15B, and the thickness is, for example, about 1 μm or greater and about 100 μm or smaller.

The inner electrode 15 includes a conductive metal as a main component and includes, for example, at least one of Cu, Ni, Ag, Pd, an alloy of Ag and Pd, or Au as a main component. It should be noted that the main component of the inner electrode refers to the component that accounts for about 50 mass % or greater of the components of the inner electrode. These metals may be compounds including these metal elements or may be alloys also including other metals. The inner electrode 15 preferably includes Cu. The inner electrode 15 is formed by sintering, on the dielectric layer 14, a conductive paste including metal powder that serves as a conductor, an organic solvent, a binder, and a dispersant.

The total number of the inner electrodes 15 is, for example, 4 or greater and 100 or smaller. The inner electrodes 15 layered. The thickness (that is, the dimension in the lamination direction T) of each of the inner electrodes 15 is, for example, about 0.5 μm or greater and about 3 μm or smaller, preferably about 1.2 μm or greater and about 2.4 μm or smaller. This is because the Q value may be too small when the thickness of the inner electrode 15 is smaller than about 1.2 μm, for example. In addition, this is because peeling may occur at the interface between the inner electrode 15 and the dielectric layer 14 due to a difference in shrinkage between the inner electrode 15 and the dielectric layer 14 during firing when the thickness of the inner electrode 15 is greater than about 2.4 μm, for example.

The inner electrode 15 includes the plurality of first inner electrodes 15A and the plurality of second inner electrodes 15B. The first inner electrode 15A is exposed only at the first end surface CA. The second inner electrode 15B is exposed only at the second end surface CB.

The plurality of first inner electrodes 15A are provided as a plurality of first inner electrode groups 16A each including of a group 41 the plurality first inner electrodes 15A, continuously adjacent to each other in the lamination direction T, that are exposed at the same end surface (specifically, the first end surface CA).

The first inner electrode groups 16A each include the plurality of first inner electrodes 15A and specifically include two first inner electrodes 15A. In the first inner electrode group 16A, the dielectric layer 14 is disposed between the first inner electrodes 15A adjacent to each other. The first inner electrode group 16A includes a first inner-side inner electrode 151A, which is the first inner electrode 15A closest to the central portion of the multilayer body 2 in the lamination direction T among the first inner electrodes 15A that constitute the first inner electrode group 16A, and a first outer-side inner electrode 152A, which is the first inner electrode 15A closest to the surface of the multilayer body 2 among the first inner electrodes 15A that constitute the first inner electrode group 16A.

The plurality of second inner electrodes 15B are provided as a plurality of second inner electrode groups 16B each including a group of the plurality of second inner electrodes 15B, continuously adjacent to each other in the lamination direction T, that are exposed at the same end surface (specifically, the second end surface CB).

The second inner electrode groups 16B each include the plurality of second inner electrodes 15B and specifically include two second inner electrodes 15B. In the second inner electrode group 16B, the dielectric layer 14 is disposed between the second inner electrodes 15B adjacent to each other. The second inner electrode group 16B includes a second inner-side inner electrode 151B, which is the second inner electrode 15B closest to the central portion of the multilayer body 2 in the lamination direction T among the second inner electrodes 15B that constitute the second inner electrode group 16B, and a second outer-side inner electrode 152B, which is the second inner electrode 15B closest to the surface of the multilayer body 2 among the second inner electrodes 15B of the second inner electrode group 16B.

The plurality of first inner electrode groups 16A and the plurality of second inner electrode groups 16B are alternately disposed in the lamination direction T. The dielectric layer 14 is disposed between the first inner electrode group 16A and the second inner electrode group 16B that are adjacent to each other. A portion of the first inner electrode group 16A and a portion of the second inner electrode group 16B face each other in the lamination direction T.

An electrostatic capacitance is generated between the first inner electrode group 16A and the second inner electrode group 16B. One first inner electrode group 16A can be considered as one first inner electrode 15A with a large thickness. One second inner electrode group 16B can be considered as one second inner electrode 15B with a large thickness. Accordingly, the same effect as one inner electrode 15 with a large thickness can be obtained, and the equivalent series resistance (ESR) can be reduced. As a result, the multilayer ceramic capacitor 1 with low loss can be obtained.

It should be noted that the first inner electrode group 16A and the second inner electrode group 16B may be collectively referred to as inner electrode groups 16. The first inner-side inner electrode 151A and the second inner-side inner electrode 151B may be collectively referred to as inner-side inner electrodes 151. The first outer-side inner electrode 152A and the second outer-side inner electrode 152B may be collectively referred to as outer-side inner electrodes 152.

In addition, the inner layer portion 11 includes, for example, a plurality of auxiliary electrodes 21 spaced apart from the inner electrodes 15 in the length direction L.

Similarly to the inner electrode 15, the auxiliary electrode 21 is made of an appropriate conductive material, which is, for example, a metal such as Cu, Ni, Ag, Pd, or Au or an alloy such as an Ag—Pd alloy including at least one of these metals.

The auxiliary electrode 21 includes a plurality of first auxiliary electrodes 21A and a plurality of second auxiliary electrodes 21B.

The first auxiliary electrodes 21A are spaced apart from the second inner electrodes 15B in the length direction L. The first auxiliary electrodes 21A are exposed at the first end surface CA. The first auxiliary electrodes 21A are connected to a first outer electrode 3A. The first auxiliary electrodes 21A and the first inner electrodes 15A face each other in the lamination direction T.

The plurality of first auxiliary electrodes 21A are provided as a plurality of first auxiliary electrode groups 22A each including a group of the plurality of first auxiliary electrodes 21A that are continuously adjacent to each other in the lamination direction T.

One first auxiliary electrode group 22A includes the plurality of first auxiliary electrodes 21A and specifically includes two first auxiliary electrodes 21A. The first auxiliary electrode groups 22A are spaced apart from the second inner electrode groups 16B in the length direction L. In the first auxiliary electrode groups 22A, the dielectric layer 14 is disposed between the first auxiliary electrode groups 22A adjacent to each other.

The second auxiliary electrodes 21B are spaced apart from the first inner electrodes 15A in the length direction L. The second auxiliary electrodes 21B are exposed at the second end surface CB. The second auxiliary electrodes 21B are connected to the second outer electrode 3B. The second auxiliary electrodes 21B and the second inner electrodes 15B face each other in the lamination direction T.

The plurality of second auxiliary electrodes 21B are provided as a plurality of second auxiliary electrode groups 22B each including a group of the plurality of second auxiliary electrodes 21B that are continuously adjacent to each other in the lamination direction T.

One second auxiliary electrode group 22B includes the plurality of second auxiliary electrodes 21B and specifically includes two second auxiliary electrodes 21B. The second auxiliary electrode groups 22B are spaced apart from the first inner electrode groups 16A in the length direction L. In the second auxiliary electrode groups 22B, the dielectric layer 14 is disposed between the second auxiliary electrode groups 22B adjacent to each other.

It should be noted that the first auxiliary electrode group 22A and the second auxiliary electrode group 22B may be collectively referred to as auxiliary electrode groups 22.

The outer layer portions 12 are made of the same material as the dielectric layers 14 of the inner layer portion 11. It should be noted that the inner electrodes 15 are not disposed in the outer layer portions 12.

The outer electrodes 3 are located on the end surfaces C and are connected to the inner electrodes 15. The outer electrodes 3 include the first outer electrode 3A, located on the first end surface CA, that is connected to the first inner electrode 15A, and the second outer electrode 3B, located on the second end surface CB, that is connected to the second inner electrode 15B. It should be noted that the first outer electrode 3A covers not only the first end surface CA but also a portion of the main surface A and a portion of the side surface B. The second outer electrode 3B covers not only the second end surface CB but also a portion of the main surface A and a portion of the side surface B.

In addition, as described above, the dimension of the multilayer body 2 in the width direction W is greater than the dimension of the multilayer body 2 in the length direction L. The multilayer ceramic capacitor 1 is a so-called LW reverse type multilayer ceramic capacitor. When the multilayer ceramic capacitor 1 is an LW reverse type multilayer ceramic capacitor, it is possible to make the distance between the outer electrodes 3 shorter and the dimension of the outer electrodes 3 in the width direction W greater than the distance and the dimension of a standard multilayer ceramic capacitor, and accordingly, the ESL can be reduced.

Each of the outer electrodes 3 includes a base electrode layer 31 located on the surface of the multilayer body 2 and a plating layer 32 located on the base electrode layer 31.

The base electrode layer 31 includes, as a main component, a conductive metal, such as, for example, Cu, Ni, Ag, Pd, Au, or an Ag—Pd alloy. The base electrode layer 31 preferably includes Cu. The base electrode layer 31 is, for example, a baked layer that includes a conductive metal and glass. The maximum thickness of the base electrode layer 31 is about 5 μm or greater and about 50 μm or smaller, for example. It should be noted that the main component of the base electrode layer refers to the component that accounts for about 50 mass % or greater of the components of the base electrode layer.

The plating layer 32 is made of, for example, a metal selected from Cu, Ni, Ag, Pd, Au, or Sn or an alloy including these metals. The plating layer 32 includes, for example, a first plating layer 321 located on the base electrode layer 31 and a second plating layer 322 located on the first plating layer 321.

The first plating layer 321 is, for example, a Ni plating layer. The second plating layer 322 is, for example, a Sn (tin) plating layer. It should be noted that the plating layer 32 may have a single-layer structure. The thickness of each layer of the plating layer 32 is preferably about 0.5 μm or greater and about 10 μm or smaller, for example.

Here, the inner-side inner electrode 151 of the inner electrode group 16 of the plurality of inner electrode groups 16 that is closest to the surface of the multilayer body 2 includes an inner bent portion 151a that is bent in a shape projecting toward the central portion in the lamination direction T. For example, the first inner-side inner electrode 151A of the first inner electrode group 16A of the plurality of first inner electrode groups 16A that is closest to the first main surface AA includes a first inner bent portion 151Aa that is bent to project toward the central portion of the multilayer body 2 in the lamination direction T.

It should be noted that the inner bent portion is the bent portion of the inner-side inner electrode in which the shortest distance between the vertex of the bent portion and an imaginary straight line (referred to as a first imaginary line L1) connecting the end portions of the inner-side inner electrode in the length direction L to each other is about 0.1 μm or greater, for example. It should be noted that the first imaginary line L1 is an imaginary straight line starting from a portion of end portions of the inner-side inner electrode in the length direction that is closest to the center in the lamination direction.

The first inner bent portion 151Aa has, for example, a substantially V-shape or a substantially U-shape that projects toward the central portion of the multilayer body 2 in the lamination direction T.

The first outer-side inner electrode 152A of the inner electrode group 16 of the plurality of first inner electrode groups 16A that is closest to the surface of the multilayer body 2 includes, for example, a first outer bent portion 152Aa that is bent in a shape projecting toward the central portion in the lamination direction T. The first outer bent portion 152Aa and the first inner bent portion 151Aa overlap each other in the lamination direction T.

The region in the inner layer portion 11 obtained by extending, in the lamination direction T, the region between the inner electrode 15 exposed at one end surface C and the auxiliary electrode 21 located between the inner electrode 15 and the other end surface C is referred to as an extension region 25. The vertex of the inner bent portion 151a is provided in the portion of the inner electrode 15, exposed at the other end surface C, that is located in the extension region 25. For example, the region in the inner layer portion 11 obtained by extending, in the lamination direction T, the region between the second inner electrode 15B and the first auxiliary electrode 21A located between the second inner electrode 15B and the first end surface CA is referred to as a first extension region 25A. The vertex of the first inner bent portion 151Aa is provided in the portion of the first inner-side inner electrode 151A that is located in the first extension region 25A. However, the vertex of the first inner bent portion 151Aa only needs to be located in the first extension region 25A, and a portion of the first inner bent portion 151Aa does not need to be provided in the first extension region 25A. It should be noted that “the vertex of the inner bent portion” refers to the portion of the inner bent portion that is closest to the central portion of the multilayer body in the lamination direction.

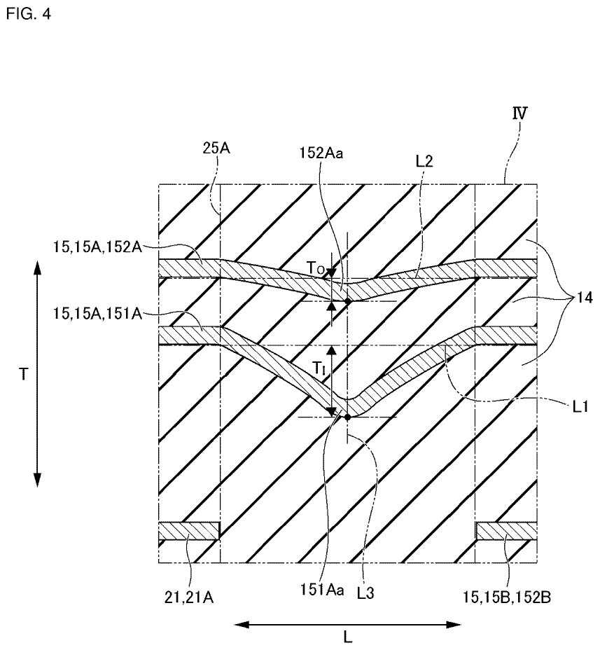

In the inner electrode group 16 of the plurality of inner electrode groups 16 that is closest to the surface of the multilayer body 2, the magnitude of the curvature of the inner bent portion 151a is greater than the magnitude of the curvature of the outer-side inner electrode 152. For example, as illustrated in FIG. 4, the magnitude (referred to as TI) of the curvature of the first inner bent portion 151Aa is greater than the magnitude (referred to as TO) of the curvature of the first outer-side inner electrode 152A.

It should be noted that the magnitude of the curvature of the inner bent portion is the shortest distance between the vertex of the bent portion of the inner-side inner electrode and the first imaginary line L1.

When the imaginary straight line connecting the end portions of the outer-side inner electrode in the length direction L to each other is referred to as a second imaginary line L2, and the imaginary straight line obtained by extending the line segment that connects the first imaginary line L1 and the vertex of the inner-side inner electrode to each other in the shortest distance is referred to as a third imaginary line L3, the magnitude of the curvature of the outer-side inner electrode is the shortest distance between the second imaginary line L2 and the intersection point between the outer-side inner electrode and the third imaginary line L3. It should be noted that the second imaginary line L2 is an imaginary straight line starting from the portion of the end portions of the outer-side inner electrode in the length direction that is closest to the center in the lamination direction. The outer-side inner electrode does not need to be bent.

The magnitude of the curvature of the inner-side inner electrode 151 is preferably, for example, about 0.5 μm or greater and about 3 μm or smaller. For example, the magnitude of the curvature of the first inner-side inner electrode 151A is about 0.5 μm or greater and about 3 μm or smaller.

The auxiliary electrode 21 is present on an extension line of the inner electrode 15. For example, the first auxiliary electrode 21A is present on an extension line of the second inner electrode 15B. The end portion of the first auxiliary electrode 21A close to the second inner electrode 15B and the end portion of the second inner electrode 15B close to the first auxiliary electrode 21A face each other in the length direction L.

It should be noted that the extension line of the inner electrode refers to an imaginary straight line that connects the central portion of one end portion in the lamination direction T and the central portion of the other end portion in the lamination direction T among the end portions of the inner electrode in the length direction L.

In addition, the second inner-side inner electrode 151B of the second inner electrode group 16B of the plurality of second inner electrode groups 16B that is closest to the second main surface AB includes a second inner bent portion 151Ba that is bent in a shape projecting toward the central portion of the multilayer body 2 in the lamination direction T. The second inner bent portion 151Ba has, for example, a substantially V-shape or a substantially U-shape that projects toward the central portion of the multilayer body 2 in the lamination direction T.

The second outer-side inner electrode 152B of the second inner electrode group 16B of the plurality of second inner electrode groups 16B that is closest to the surface of the multilayer body 2 includes, for example, a second outer bent portion 152Ba that is bent in a shape projecting toward the central portion in the lamination direction T. The second outer bent portion 152Ba and the second inner bent portion 151Ba overlap each other in the lamination direction T.

The region in the inner layer portion 11 obtained by extending, in the lamination direction T, the region between the first inner electrode 15A and the second auxiliary electrode 21B located between the first inner electrode 15A and the second end surface CB is referred to as a second extension region 25B. The vertex of the second inner bent portion 151Ba is provided in the portion of the second inner-side inner electrode 151B that is located in the second extension region 25B. However, the vertex of the second inner bent portion 151Ba only needs to be located in the second extension region 25B, and a portion of the second inner bent portion 151Ba does not need to be provided in the second extension region 25B.

The magnitude of the curvature of the second inner bent portion 151Ba is greater than the magnitude of the curvature of the second outer bent portion 152Ba.

The magnitude of the curvature of the second inner-side inner electrode 151B is preferably about 0.5 μm or greater and about 3 μm or smaller, for example.

The second auxiliary electrode 21B is present on an extension line of the first inner electrode 15A.

The first inner electrode group 16A and the second inner electrode group 16B may be collectively referred to as the inner electrode groups 16. The first inner-side inner electrode 151A and the second inner-side inner electrode 151B may be collectively referred to as the inner-side inner electrodes 151. The first inner bent portion 151Aa and the second inner bent portion 151Ba may be collectively referred to as the inner bent portions 151a. The first outer-side inner electrode 152A and the second outer-side inner electrode 152B may be collectively referred to as the outer-side inner electrodes 152. The first outer bent portion 152Aa and the second outer bent portion 152Ba may be collectively referred to as outer bent portions 152a. The first extension region 25A and the second extension region 25B may be collectively referred to as the extension regions 25.

Next, a non-limiting example of a method of manufacturing a multilayer ceramic capacitor 1 according to an example embodiment will be described.

First, a dielectric sheet, a conductive paste for the inner electrodes, and a conductive paste for the auxiliary electrodes are prepared. The dielectric sheet, the conductive paste for the inner electrodes, and the conductive paste for the auxiliary electrodes include binders and solvents. The binders and the solvents are, for example, known ones. The conductive paste for the inner electrodes and the conductive paste for the auxiliary electrodes include metal powder. It should be noted that the components included in the conductive paste for the inner electrodes and the components included in the conductive paste for the auxiliary electrodes may differ from each other.

Next, the conductive paste for the inner electrodes and the conductive paste for the auxiliary electrodes are applied to the dielectric sheet so as to form predetermined patterns by using, for example, screen printing or gravure printing. The conductive paste for the inner electrodes and the conductive paste for the auxiliary electrodes are applied with these conductive pastes spaced apart in the length direction L. As a result, a dielectric sheet for the inner layer portion to which the conductive pastes for the inner electrodes and the conductive pastes for the auxiliary electrodes have been applied is obtained.

A dielectric sheet to which inner electrode patterns and auxiliary electrode patterns are not applied is prepared as a dielectric sheet for the outer layer portion. It should be noted that the components included in the dielectric sheet for the inner layer portion and the components included in the dielectric sheet for the outer layer portion may differ from each other.

Subsequently, the dielectric sheet for the inner layer portion is laminated. When the inner layer portion is laminated, a plurality of dielectric sheets to which the conductive paste that serves as the first inner electrode and the conductive paste that serves as the second auxiliary electrode have been applied are continuously laminated, a plurality of dielectric sheets to which the conductive paste that serves as the second inner electrode and the conductive paste that serves as the first auxiliary electrode have been applied are continuously laminated, and this process is repeated. As a result, the first inner electrode group 16A, the second inner electrode group 16B, the first auxiliary electrode group 22A, and the second auxiliary electrode group 22B are formed.

Here, the dielectric sheet for the inner layer portion is laminated while being pressed in the lamination direction. The dielectric sheet for the inner layer portion may be pressed after one sheet is laminated or after the plurality of sheets are laminated. When the dielectric sheet is pressed, of the pressure used to press the dielectric sheet, the pressure applied to the portion of the inner electrode to be bent is set to be greater than the pressure applied to other portions. Accordingly, the portion of the conductive paste for the inner electrodes that is located in the extension region is bent so as to project toward the central portion of the multilayer body in the lamination direction T. As a result, a curvature that serves as the inner bent portion 151a is formed in the conductive paste for the inner electrodes. In addition, the magnitude of the curvature of the inner bent portion 151a is adjusted by adjusting the magnitude of the pressure during the pressing.

It should be noted that, when the auxiliary electrodes 21 are provided in the inner layer portion 11, the pressed conductive paste for the inner electrodes deforms so as to enter the region between the conductive paste for the inner electrodes that is previously laminated and the conductive paste for the auxiliary electrodes, and accordingly, the inner bent portion 151a can be suitably formed without significant differences between the pressures applied to individual portions of the conductive paste. Accordingly, by the auxiliary electrodes 21 being provided in the inner layer portion 11, the inner bent portion 151a can be easily formed in the inner electrode 15. In addition, the inner bent portion 151a can be easily formed at an appropriate position (that is, at a portion located in the extension region 25). However, even when the auxiliary electrodes 21 are not provided in the inner layer portion 11, during the press process, the inner bent portion 151a can be formed in the inner-side inner electrode 151 by applying a stronger pressure to the portion to be bent of the conductive paste for the inner electrodes than other portions.

In addition, when, for example, the dielectric sheet to which the conductive paste that serves as the outer-side inner electrode 152 has been applied is laminated, the conductive paste and the dielectric sheet are bent along the curvature of the inner bent portion 151a, and accordingly, the outer bent portion 152a is formed.

The dielectric sheet that forms a portion of the inner layer portion 11 close to the first main surface AA and the dielectric sheet defining a portion of the inner layer portion 11 close to the second main surface AB are, for example, laminated separately from each other and then combined with each other. Accordingly, a curvature that projects toward the central portion of the multilayer body 2 in the lamination direction T can be formed in both the inner-side inner electrode 151 located in a portion of the multilayer body 2 close to the first main surface AA and the inner-side inner electrode 151 located in a portion of the multilayer body 2 close to the second main surface AB.

Subsequently, the dielectric sheets for the outer layer portion are laminated on both sides in the lamination direction of the laminated dielectric sheet for the inner layer portion. The dielectric sheets for the outer layer portion are thermally bonded to the dielectric sheets for the inner layer portion. As a result, a master block is obtained. The master block is pressed in the lamination direction by a method, such as hydrostatic pressing.

It should be noted that each of the outer layer portions 12 may include a plurality of laminated dielectric sheets or a single dielectric sheet.

Subsequently, the mother block is cut along the cutting lines corresponding to the dimensions of the multilayer body 2. The master block is cut, for example, in the length direction L and the width direction W. As a result, a plurality of rectangular parallelepiped blocks (referred to as multilayer chips) are obtained. It should be noted that the corner portions and the ridge portions of the multilayer chips are preferably rounded, for example, by barrel polishing.

Subsequently, the multilayer chips are heated in a nitrogen atmosphere for a predetermined time at a specified firing temperature. As a result, the multilayer body 2 is obtained. It should be noted that, when the inner electrode 15 includes Cu as a main component, since Cu has relatively excellent oxidation resistance, the atmosphere in which the dielectric layers 14 and the inner electrodes 15 are simultaneously fired can be set to a side closer to oxidization. This can decrease or prevent the reduction of Ca(Zr, Ti)O3-based compounds. Perovskite-type compounds, such as Ca(Zr, Ti)O3-based compounds, exhibit semiconductor properties and do not exhibit good dielectric properties when reduced, but such problems can be prevented from occurring.

Subsequently, the base electrode layer 31 is formed on each of the end surfaces C of the multilayer body 2. A conductive paste including glass and metal is applied onto the multilayer body 2. The base electrode layer 31 is formed so as to cover, for example, each of the end surfaces C, a portion of each of the main surfaces A, and a portion of each of the side surfaces B. However, the present invention is not limited to this example, and the base electrode layer 31 may also be located only on each of the end surfaces C.

Subsequently, the multilayer body 2 in which the base electrode layer 31 has been formed is heated for a predetermined time at a specified firing temperature in a nitrogen atmosphere. As a result, the base electrode layer 31 is baked onto the multilayer body 2. It should be noted that the multilayer body firing process and the base electrode layer burning process may be performed simultaneously after the material of the base electrode layer is located on the multilayer chip. In addition, when the base electrode layer 31 includes Cu as a main component, the atmosphere of firing can be set to a side closer to oxidization. This can suppress the reduction of Ca(Zr, Ti)O3-based compounds.

Subsequently, the plating layers 32 are formed on the base electrode layer 31. First, the first plating layers 321 are formed on the base electrode layer 31. Subsequently, the second plating layers 322 are formed on the first plating layers 321. The first plating layers 321 are formed, for example, by Ni plating. The second plating layers 322 are formed, for example, by Sn plating. The first plating layers 321 and the second plating layers 322 are sequentially formed, for example, by an electrolytic plating method.

As a result, the multilayer ceramic capacitor 1 illustrated in FIG. 1 is obtained.

Examples and comparative examples will be described. The experimental methods and the experimental results will be described below.

As samples for experimental examples and comparative examples, example multilayer ceramic capacitors having structures (structures illustrated in FIGS. 1 to 4) similar to the structure of the multilayer ceramic capacitor 1 have been produced. The method of manufacturing samples of the multilayer ceramic capacitors is the manufacturing method according to the example embodiments described above. The comparative example is comparative example 1. The experimental examples are experimental example 1 to experimental example 7. For each of the experimental examples and the comparative examples, 10,000 samples of the multilayer ceramic capacitor have been produced.

In the experimental examples and the comparative examples, the dimensions of the multilayer ceramic capacitor are about 0.3 mm in length, about 0.6 mm in width, and about 0.18 mm in thickness.

The magnitudes of the curvatures of the inner electrodes differ from each other between the experimental examples and the comparative examples. The magnitudes of the curvatures of the inner electrodes for the experimental examples have been adjusted by adjusting the lamination pressure in the lamination process. In the samples of the comparative examples, the lamination pressure in the lamination process has been kept constant at each portion of the inner electrode.

The magnitude of the curvature of the bent portion of the inner electrode for each of the experimental examples and the comparative examples is illustrated in Table 1. It should be noted that the magnitude of the curvature of the inner bent portion may be referred to as TI, and the magnitude of the curvature of the outer-side inner electrode may be referred to as TO.

Next, measurements and evaluations of the produced samples were performed according to the following method. Measurements and the like of the withstand voltage, the magnitude of the curvature of the inner electrode, and the inner structural defect rate were performed.

The withstand voltage measurement (DC-BDV test) for each sample was performed under the conditions of a voltage rising speed of about 100 V/s and a detection current of about 10 mA.

For each of the examples and the comparative examples, the withstand voltage was measured for 20 samples randomly extracted from 10,000 samples. The average value of the obtained withstand voltages was taken as the withstand voltage for each of the examples and the comparative examples.

It should be noted that, for the samples subjected to withstand voltage measurement, withstand voltage measurement was performed, and other measurements were performed.

The magnitude of the curvature of the inner bent portion and the magnitude of the curvature of the outer-side inner electrode were measured for the inner electrode group of the inner electrode groups that is closest to the surface of the multilayer body.

An LT cross-section passing through the central portion of the multilayer ceramic capacitor in the width direction W was exposed by polishing and observed with an optical microscope. In the inner electrode group of the inner electrode groups that is closest to the surface of the multilayer body, the magnitude of the curvature of the inner bent portion and the magnitude of the curvature of the outer-side inner electrode were measured according to the definition described in the example embodiments.

For each of the examples and the comparative examples, the magnitude of the curvature of the inner bent portion and the magnitude of the curvature of the outer-side inner electrode were measured for 10,000 samples. The average of the obtained values of the magnitude of the curvature of the inner bent portion was taken as the magnitude of the curvature of the inner bent portion for each of the examples and the comparative examples. The average of the obtained values of the magnitude of the curvature of the outer-side inner electrode was taken as the magnitude of the curvature of the outer-side inner electrode for each of the examples and the comparative examples.

In addition, for each of the examples and the comparative examples, the value (sometimes referred to as TI/TO) obtained by diving the magnitude of the curvature of the inner bent portion by the magnitude of the curvature of the outer-side inner electrode was calculated.

The LT cross-section passing through the central portion of the multilayer ceramic capacitor in the width direction W was observed with an optical microscope. The presence or absence of occurrence of interlayer peeling between the inner electrode group of the inner electrode groups that is closest to the surface of the multilayer body and the dielectric layer adjacent to this inner electrode, and the presence or absence of occurrence of cracks in the dielectric layer adjacent to this inner electrode group were observed. The sample in which at least one of interlayer peeling and cracks was observed classified as a sample with inner structural defects.

For each of the examples and the comparative examples, the number of samples with inner structural defects was counted for 10,000 samples. The number of samples with inner structural defects of 10,000 samples was defined as the inner structural defect rate.

For each of the examples and the comparative examples, judgment of good or bad was performed.

When the inner structural defect rate was 0/10,000 and the withstand voltage is 800 V or higher, the judgment result was rated “Good”.

When the judgment result was not good, but the inner structural defect rate was smaller than 10/10,000 and the withstand voltage was 800 V or higher, then the judgment result was rated “Generally Good”.

When the inner structural defect rate was 10/10,000 or higher, the judgment result was rated “No Good”.

In Table 1, TI (μm), TO (μm), TI/TO, the inner structural defect rate, the withstand voltage (V), and the judgment result are indicated for comparative example 1 and experimental example 1 to experimental example 7.

TABLE 1

| | | | | Inner | Withstand | |
|---|---|---|---|---|---|---|
| | T_{I} | T_{O} | | Structural | Voltage | |
| | (μm) | (μm) | T_{I}/T_{O} | Defect Rate | (V) | Judgment |
| Comparative | 0.05 | 0.05 | 1.0 | 10/10,000 | 852 | Good |
| Example 1 | | | | | | |
| Experimental | 0.1 | 0.06 | 1.7 | 3/10,000 | 849 | Generally |
| Example 1 | | | | | | Good |
| Experimental | 0.5 | 0.05 | 10.0 | 0/10,000 | 837 | Good |
| Example 2 | | | | | | |
| Experimental | 1 | 0.12 | 18.3 | 0/10,000 | 842 | Good |
| Example 3 | | | | | | |
| Experimental | 2 | 0.07 | 28.6 | 0/10,000 | 828 | Good |
| Example 4 | | | | | | |
| Experimental | 2.5 | 0.11 | 22.7 | 0/10,000 | 830 | Good |
| Example 5 | | | | | | |
| Experimental | 3 | 0.13 | 23.1 | 0/10,000 | 832 | Good |
| Example 6 | | | | | | |
| Experimental | 6 | 0.14 | 42.9 | 0/10,000 | 793 | Generally |
| Example 7 | | | | | | Good |

In comparative example 1, TI was 0.05 μm. In comparative example 1, the inner structural defect rate was 10/10,000 and the judgment result was “No Good”. However, in comparative example 1, the withstand voltage had a good result of 852 V.

In experimental example 1 to experimental example 7, TI was 0.1 μm or greater and 6 μm or smaller. In experimental example 1 to experimental example 7, the inner structural defect rate had a good result of 3/10,000 or lower. In particular, in experimental example 2 to 7, the inner structural defect rate had a good result of 0/10,000.

In experimental example 2 to experimental example 7, TI/TO was about 8.3 or greater and about 42.9 or smaller. In the samples in experimental example 2 to experimental example 7, the inner-side inner electrode was relatively significantly bent and the outer-side inner electrode was little bent. It is thought that the adhesion between the dielectric layer and the inner-side inner electrode could be improved because the inner electrode was relatively significantly bent. It is thought that the adhesion between the outer-side inner electrode and the outer layer portion could be suppressed from being reduced because the outer-side inner electrode was little bent. It is thought that these suitably suppressed inner structural defects from occurring.

In experimental example 7, TI was about 6 μm. In experimental example 7, the inner structural defect rate had a good result of 0/10,000. However, in experimental example 7, the withstand voltage had a value of about 793 V, which was slightly lower than the results of experimental example 1 to experimental example 6. It is thought that, in experimental example 7, TI was too large and the thickness of the dielectric near the bent portion of the inner-side inner electrode was too thin, and accordingly, the withstand voltage was reduced.

As described above, it was confirmed that inner structural defects can be suitably prevented from occurring and the withstand voltage can be kept within a good range by setting TI to about 0.5 μm or greater and about 3 μm or smaller, for example, as illustrated in the results of experimental example 2 to experimental example 6. It was confirmed that the multilayer ceramic capacitor with excellent reliability can be obtained by setting TI to about 0.5 μm or greater and about 3 μm or smaller, for example. In addition, it was also confirmed that inner structural defects can be suitably prevented from occurring and the withstand voltage can be kept within a good range with greater certainty by setting TI/TO to about 8.3 or greater and about 28.6 or smaller, for example.

According to the example embodiments, the following effects can be obtained.

According to the example embodiments described above, the multilayer ceramic capacitor 1 includes the multilayer body 2, the pair of the outer electrodes 3, located on the end surfaces C of the multilayer body 2, that are connected to the inner electrodes 15, and the dimension of the multilayer body 2 in the width direction W is greater than the dimension of the multilayer body in the length direction L. The plurality of inner electrodes 15 are provided as the plurality of inner electrode groups 16 each including a group of the plurality of inner electrodes 15, continuously adjacent to each other in the lamination direction T, that are exposed at the same end surface C, and the inner electrode groups 16 each include the inner-side inner electrode 151 that is one of the inner electrodes 15 of the inner electrode group 16 that is closest to the central portion of the multilayer body 2 in the lamination direction T and the outer-side inner electrode that is one of the inner electrodes 15 of the inner electrode group 16 that is closest to the surface of the multilayer body 2. The inner-side inner electrode 151 of the inner electrode group 16 of the plurality of inner electrode groups 16 that is closest to the surface of the multilayer body 2 includes the inner bent portion 151a that projects toward the central portion of the multilayer body 2 in the lamination direction T.

In the structure, the multilayer ceramic capacitor 1 is a so-called LW reverse type multilayer ceramic capacitor. Accordingly, the ESL of the multilayer ceramic capacitor 1 can be reduced. In addition, in the LW reverse type multilayer ceramic capacitor 1, the ESL can also be suitably reduced in a high-frequency range.

In addition, since one inner electrode group 16 includes the plurality of inner electrodes 15, the same effect as one inner electrode with a large thickness can be obtained. As a result, the ESR can be reduced in the inner electrode 15. In a high-frequency range, the ESR of the multilayer ceramic capacitor 1 can be suitably reduced by reducing the ESR of the inner electrode 15. Accordingly, the ESR of the multilayer ceramic capacitor 1 can be suitably reduced in a high-frequency range.

Since a step affected by the thickness of the inner electrode 15 is easily generated around the inner electrode group 16 close to the surface of the multilayer body 2, the adhesion between the dielectric layer 14 and the inner-side inner electrode 151 is easily reduced. However, since the inner-side inner electrode 151 includes the inner bent portion 151a, an anchoring effect is easily produced between the inner-side inner electrode 151 and the dielectric layer 14. As a result, the adhesion between the inner-side inner electrode 151 and the dielectric layer 14 can be improved. As a result, cracks, interlayer peeling, or the like around the inner electrode group 16 can be prevented from occurring.

Accordingly, it is possible to provide the multilayer ceramic capacitor 1 that reduce or prevent energy loss in a high-frequency range and reduce or prevent inner structural defects while achieving ESL reduction effects.

In the example embodiments described above, the inner layer portion 11 includes the auxiliary electrodes 21 spaced apart from the inner electrodes 15 in the length direction L. When the region obtained by extending, in the lamination direction T, the region in the inner electrodes 15 between the inner electrodes 15 exposed at one end surface C and the auxiliary electrodes 21 located between the inner electrodes 15 and the other end surface C is the extension region, the vertex of the inner bent portion 151a is provided in the portion of the inner-side inner electrode 151, exposed at the other the end surface C, that is located in the extension region 25.

In the structure, since the auxiliary electrodes 21 are provided in the inner layer portion 11, the percentage of metal in the multilayer body 2 increases. The toughness of metal is higher than the toughness of the dielectric layer 14. Since this can increase the mechanical strength of the multilayer body 2, cracks can be prevented from occurring in the multilayer body 2.

In the extension region 25, the adhesion between the inner electrode 15 and the dielectric layer 14 is smaller than that in the portion in which the inner electrode groups 16 face each other and that in the portion in which the inner electrode groups 16 face the auxiliary electrodes 21. However, in the structure, the adhesion between the inner-side inner electrode 151 and the dielectric layer 14 can be further improved by the inner bent portion 151a being disposed in the extension region 25. As a result, inner structural defects can be more suitably reduced or prevented.

During pressing in the lamination process, the curvature of the portion of the inner electrode 15 that faces the auxiliary electrode 21 in the lamination direction T can be reduced or prevented. Since this can reduce or prevent the curvature of the inner electrode 15 around the end portion in the length direction L, the inner electrode 15 can be easily bent in a substantially V shape or a substantially U shape.

In the example embodiments described above, in the inner electrode group 16 of the plurality of inner electrode groups 16 that is closest to the surface of the multilayer body 2, the magnitude of the curvature of the inner bent portion 151a is greater than the magnitude of the curvature of the outer-side inner electrode 152.

In the structure, the adhesion between the inner-side inner electrode 151 and the dielectric layer can be improved by the inner-side inner electrode 151 being more greatly bent. In addition, when the outer bent portion 152a is greatly bent toward the central portion of the multilayer body 2, the adhesion between the outer bent portion 152a and the outer layer portion 12 may be reduced, but such defects can be reduced or prevented. As a result, inner structural defects can be more suitably reduced or prevented. In the example embodiments described above, the magnitude of the curvature of the inner bent portion 151a is about 0.5 μm or greater and about 3 μm or smaller, for example.

In the structure, it is possible to reduce or prevent peeling from occurring at the interface between the inner electrode 15 and the dielectric layer 14 due to the difference in shrinkage between the inner electrode 15 and the dielectric layer 14 during firing while sufficiently reducing or preventing energy loss in a high-frequency range.

In the example embodiments described above, the auxiliary electrode 21 is present on an extension line of the inner electrode 15.

In the structure, since the dimension of the multilayer body 2 in the lamination direction T can be prevented from increasing due to the thickness of the auxiliary electrode 21, the multilayer ceramic capacitor 1 can be easily made to be thin.

In the example embodiments described above, the inner electrode 15 includes Cu, the outer electrode 3 includes the base electrode layer 31 located on the surface of the multilayer body 2, and the base electrode layer 31 includes Cu.

In the structure, since Cu has low electrical resistance and low conductor loss caused by the conductor, the loss in the multilayer ceramic capacitor can be lower.

In the example embodiments described above, the dielectric layer 14 includes TiO2 or has a composition represented by (Ca_{1-x-y}, Srₓ, Ba_{y})m(Zr_{1-z-α}, Ti_{z}, Hf_{α})O₃ where x is about 0 or greater and about 1 or smaller, y is about 0 or greater and about 0.4 or smaller, m is about 1.0 or greater and about 1.1 or smaller, z is about 0 or greater and about 0.2 or smaller, and x is about 0 or greater and about 0.3 or smaller, for example.

In the structure, it is possible to obtain the multilayer ceramic capacitor that has a small rate of change of electrostatic capacitance with respect to temperature and small loss.

Example embodiments of the present invention have been described above, but the present invention is not limited to the example embodiments described above, and various changes and modifications can be made.

One inner electrode group 16 includes two inner electrodes 15 in the example embodiments described above, but one inner electrode group may include three or more inner electrodes.

The first outer-side inner electrode 152A includes the first outer bent portion 152Aa and the second outer-side inner electrode 152B includes the second outer bent portion 152Ba in the example embodiment described above, but the first outer bent portion 152Aa and the second outer bent portion 152Ba are not essential components. The outer-side inner electrode preferably is not bent toward the central portion of the multilayer body in the lamination direction to enable reduction or prevention of the adhesion between the outer-side inner electrode and the outer layer portion.

The first inner-side inner electrode 151A includes the first inner bent portion 151Aa and the second inner-side inner electrode 151B includes the second inner bent portion 151Ba in the example embodiments described above, but at least one of the first inner-side inner electrode 151A and the second inner-side inner electrode 151B only needs to include the inner bent portion. However, when both the first inner-side inner electrode 151A and the second inner-side inner electrode 151B include the inner bent portion, the effects described above can be obtained more suitably.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body that includes an inner layer portion including a plurality of dielectric layers and a plurality of inner electrodes that are alternately laminated together, the multilayer body including a pair of main surfaces that face away from each other in a lamination direction, a pair of side surfaces that face away from each other in a width direction orthogonal to the lamination direction, and a pair of end surfaces that face away from each other in a length direction orthogonal to the lamination direction and the width direction; and
outer electrodes, located on the end surfaces, that are connected to the inner electrodes; wherein
a dimension of the multilayer body in the width direction is greater than a dimension of the multilayer body in the length direction;
the plurality of inner electrodes are provided as a plurality of inner electrode groups each including a group of the plurality of inner electrodes, continuously adjacent to each other in the lamination direction, that are exposed at one of the end surfaces;
the inner electrode groups each include an inner-side inner electrode that is one of the inner electrodes of each of the inner electrode groups that is closest to a central portion of the multilayer body in the lamination direction, and an outer-side inner electrode that is one of the inner electrodes of each of the inner electrode groups that is closest to a surface of the multilayer body; and
the inner-side inner electrode of the inner electrode group of the plurality of inner electrode groups that is closest to the surface of the multilayer body includes an inner bent portion projecting toward the central portion of the multilayer body in the lamination direction.

2. The multilayer ceramic capacitor according to claim 1, wherein
the inner layer portion includes an auxiliary electrode spaced apart from the inner electrodes in the length direction;
when a region obtained by extending, in the lamination direction, a region, in the inner layer portion, that is located between the inner electrodes exposed at one of the end surfaces and the auxiliary electrode located between the inner electrodes and another of the end surfaces is an extension region, a vertex of the inner bent portion is provided in a portion of the inner-side inner electrode exposed at the other of the end surfaces, the portion being located in the extension region.

3. The multilayer ceramic capacitor according to claim 1, wherein, in the inner electrode group of the plurality of the inner electrode groups that is closest to the surface of the multilayer body, a magnitude of curvature of the inner bent portion is greater than a magnitude of curvature of the outer-side inner electrode.

4. The multilayer ceramic capacitor according to claim 1, wherein a magnitude of curvature of the inner bent portion is about 0.5 μm or greater and about 3 μm or smaller.

5. The multilayer ceramic capacitor according to claim 2, wherein the auxiliary electrode is present on an extension line of the inner electrode.

6. The multilayer ceramic capacitor according to claim 1, wherein
the inner electrodes include Cu;
the outer electrodes each include a base electrode layer located on the surface of the multilayer body; and
the base electrode layer includes Cu.

7. The multilayer ceramic capacitor according to claim 1, wherein the dielectric layer includes TiO2 or has a composition represented by (Ca_{1-x-y}, Srₓ, Ba_{y})m(Zr_{1-z-α}, Ti_{z}, Hf_{α})O₃ where x is about 0 or greater and about 1 or smaller, y is about 0 or greater and about 0.4 or smaller, m is about 1.0 or greater and about 1.1 or smaller, z is about 0 or greater and about 0.2 or smaller, and α is about 0 or greater and about 0.3 or smaller.

8. The multilayer ceramic capacitor according to claim 2, wherein the multilayer ceramic capacitor is a two-terminal capacitor.

9. The multilayer ceramic capacitor according to claim 2, wherein the auxiliary electrode includes a plurality of first auxiliary electrodes and a plurality of second auxiliary electrodes.

10. The multilayer ceramic capacitor according to claim 9, wherein the plurality of first auxiliary electrodes are spaced apart from the second inner electrodes in the length direction and exposed at the first end surface, and the plurality of second auxiliary electrodes spaced apart from the first inner electrodes in the length direction and exposed at the second end surface.

11. The multilayer ceramic capacitor according to claim 1, wherein each of the outer electrodes includes a base electrode layer and a plating layer.

12. The multilayer ceramic capacitor according to claim 11, wherein the base electrode layer includes Cu, Ni, Ag, Pd, Au, or an Ag—Pd alloy.

13. The multilayer ceramic capacitor according to claim 11, wherein the base electrode layer includes a conductive metal and glass.

14. The multilayer ceramic capacitor according to claim 11, wherein the plating layer includes Cu, Ni, Ag, Pd, Au, or Sn or an alloy of Cu, Ni, Ag, Pd, Au, or Sn.

15. The multilayer ceramic capacitor according to claim 11, wherein the plating layer includes a Ni plating layer and a Sn plating layer.

16. The multilayer ceramic capacitor according to claim 1, wherein the inner bent portion has a substantially V-shape or a substantially U-shape.

17. The multilayer ceramic capacitor according to claim 1, wherein the multilayer ceramic capacitor is a LW reverse multilayer ceramic capacitor.

18. The multilayer ceramic capacitor according to claim 1, wherein the outer-side inner electrode is a first outer-side inner electrode that includes a first outer bent portion.

19. The multilayer ceramic capacitor according to claim 18, wherein the inner electrode groups include a second outer-side inner electrode that includes a second outer bent portion.

20. The multilayer ceramic capacitor according to claim 19, wherein the inner bent portion is a first inner bent portion, and the inner electrode groups include a second inner bent portion.
